(19) United States
(12) Patent Application Publication
(10) Pub. No.: US 2015/0375800 A1
(43) Pub. Date: Dec. 31, 2015

(54) Composite Reinforcement for Vehicle Body Structures

(71) Applicant: Ford Global Technologies, LLC, Dearborn, MI (US)

(72) Inventors: Darrin Neil Wagner, Bloomfield Hills, MI (US); Charles Ko, Novi, MI (US); Leonard Anthony Shaner, New Baltimore, MI (US); Christopher John May, Novi, MI (US); Roman Grygosinski, Livonia, MI (US); Andrey M. Ilinich, Dearborn, MI (US); Stephen Kernosky, Livonia, MI (US); S. George Luckey, JR., Dearborn, MI (US); Edgar Edward Donabedian, Livonia, MI (US)

(21) Appl. No.: 14/319,095

(22) Filed: Jun. 30, 2014

(51) Int. Cl. B62D 29/04; B62D 25/04

(52) U.S. Cl. CPC B62D 29/046; B62D 25/04

(57) ABSTRACT

A reinforcement received between facing surfaces of adjacent panels that may be part of a hinge pillar of a vehicle such as a pickup truck and the panels may be aluminum. The reinforcement may be a one-piece molded structure. The reinforcement includes ribs that extend between the facing surfaces in a lattice arrangement defining a plurality of cells. The cells may have a number of transverse walls defining a perimeter of a polygon. The polygonal cells may have a facing wall on one side of the cell closing the cell. The facing wall may have an adhesive that is applied to the reinforcement and expanded in a paint bake oven to secure the reinforcement to the adjacent panels.

### TECHNICAL FIELD

This disclosure relates to reinforcements for vehicle body structures that are assembled into interstitial spaces between components of the body structures.

### BACKGROUND

Vehicle body structures are subject to vehicle crash safety testing and vehicles are designed to obtain superior test results without adding substantial weight to the vehicle. It is a substantial challenge to develop a vehicle architecture capable of withstanding frontal impact loads applied in frontal impact tests. Small Overlap Rigid Barrier (SORB) tests simulate a frontal impact of a vehicle with a rigid barrier outboard of the frame rails. SORB test loads are often channeled into a front hinge pillar area of the vehicle. Intrusion into the passenger compartment are measured at multiple locations in the SORB test.

One response to managing frontal impact loads is to add metal reinforcements that are welded or fastened to hinge pillar component parts or by incorporating thicker and heavier component parts. Adding metal reinforcements increases manufacturing costs and complexity. Adding metal reinforcements or using thicker panels to fabricate the component parts is directly counterproductive to weight reduction priorities that must be met to achieve fuel economy standards facing vehicle manufacturers.

While the problem of managing loads at the front hinge pillar area is important for SORB tests, other vehicle body structures that are redesigned to reduce weight are subject to other test and performance requirements that require a lightweight solution.

Pickup trucks are motor vehicles with a front passenger area, often referred to as a cab, and an open top rear cargo area, often referred to as a box. The cab and box are typically separate assemblies mounted on a ladder frame. However, cabs and boxes may be a singular body structure mounted on a frame or part of the same unibody structure. Pickup trucks are popular largely because the box allows them to be utilized in so many different ways, including carrying a variety of types of cargo and towing various types of trailers.

Traditionally, the majority of body structures on pickup trucks have been formed from steel alloys. Through years of experience, pickup truck designers have learned how to engineer steel truck body parts that withstand the variety of demanding pickup truck applications. The current regulatory and economic environments have increased the importance of making pickup trucks more fuel efficient as well as functional and durable. One way to reduce the fuel consumption of a vehicle is to reduce vehicle structure weight by using aluminum body components on the pickup truck.

Aluminum alloys typically have a higher strength to weight ratio than steel alloys. Consequently, replacing steel with aluminum offers the potential for weight reduction. However, the elastic modulus of aluminum is generally lower than the elastic modulus of steel. Thus it may be advantageous to design a vehicle architecture including an aluminium hinge pillar to obtain superior test results comparable to a vehicle architecture using traditional steel materials.

The above problems and other problems are addressed by this disclosure as summarized below.

### SUMMARY

According to one aspect of this disclosure, an impact absorbing reinforcement is provided that is received between facing surfaces of adjacent panels. In one embodiment, the reinforcement may include a reinforcement body including ribs that extend between the facing surfaces in a lattice arrangement and may define a plurality of cells. A first plurality of walls is provided on a first plurality of cells on one side of the ribs and a second plurality of walls is provided on a second plurality of the cells on a second side of the ribs.

According to other aspects of this disclosure, the first plurality of walls and the second plurality of walls are not provided on the same cells. A first set of the ribs may extend in a lateral direction and a vertical direction and a second set of ribs may extend in a lateral direction and a horizontal direction between facing surfaces of the adjacent panels that extend in a longitudinal direction and a vertical direction. The cells may be polygonal cells that are open on one lateral side. The first plurality of cells may be open on an inner lateral side and the second plurality of cells may be open on an outer lateral side. An adhesive may be provided on at least some of the first plurality of cells and on at least some of the second plurality of cells to adhere the reinforcement to the facing surfaces of the adjacent panels.

According to other aspects of this disclosure, the adjacent panels may include a hinge pillar outer panel and a hinge pillar reinforcement panel. The first plurality of cells may be open on a side facing the hinge pillar outer panel and closed by one of the walls on a side facing the hinge pillar reinforcement. The second plurality of cells may be open on the side facing the hinge pillar reinforcement and closed by one of the walls on the side facing the hinge pillar outer panel. An adhesive may be applied to the walls to permanently attach the reinforcement to the hinge pillar outer panel and the hinge pillar reinforcement panel. During installation, clips or other fasteners may be used to temporarily hold the reinforcement in place until the adhesive is expanded and activated in a paint oven. The reinforcement body and the first and second plurality of walls may be formed as a one-piece molded member.

According to another aspect of this disclosure, a combination vehicle body structure is disclosed that includes a hinge pillar defining a receptacle, and an A-pillar/roof rail assembly received in the receptacle of the hinge pillar. The A-pillar/roof rail assembly includes an intermediate portion extending along on side of a roof, an upper portion extending along a lateral side of a windshield, and a lower extension portion.

According to other aspects of this disclosure the hinge pillar may further comprise a hinge pillar outer panel, a hinge pillar inner panel and at least one hinge pillar reinforcement panel that are assembled between the hinge pillar outer panel and the hinge pillar inner panel.

The combination may further comprise a reinforcement received between facing surfaces, for example, facing surfaces of the hinge pillar outer panel and the hinge pillar reinforcement panel. The reinforcement may further comprise a reinforcement body including intersecting ribs that extend between the facing surfaces in a lattice arrangement defining a plurality of cells and a first plurality of walls on a first plurality of cells on one side of the ribs and a second plurality of walls on a second plurality of the cells on a second side of the ribs. The first plurality of cells may be open on a side facing the hinge pillar outer panel and closed by one of the walls on a side facing the hinge pillar reinforcement. The second plurality of cells may be open on the side facing the hinge pillar reinforcement and closed by one of the walls on the side facing the hinge pillar outer panel or hinge pillar inner panel. An adhesive may be applied to the walls to adhere the reinforcement to the hinge pillar outer panel and the hinge pillar reinforcement panel. It should be understood that the reinforcement could be configured to be inserted in a space between other body structures to increase impact resistance.

According to other aspects of this disclosure, the A-pillar/roof rail assembly may be a hydro-formed tubular member that is formed in one piece to include an intermediate portion, an upper portion, and a lower extension portion. The intermediate portion may extend in an angular orientation downwardly and forwardly relative to the upper portion. The lower extension portion may extend vertically downwardly from the intermediate portion. The lower extension portion may extend into a receiving area, or receptacle portion, formed within the hinge pillar.

The above aspects of this disclosure and other aspects are described below with reference to the drawings.

### BRIEF DESCRIPTION OF THE DRAWINGS

FIG. 1 is a fragmentary side elevation view of a hinge pillar and an A-pillar/roof rail assembly of a vehicle.

FIG. 2 is an exploded perspective view showing a hinge pillar with a hinge pillar outer panel and a composite reinforcement exploded away from a hinge pillar reinforcement and inner hinge pillar.

FIG. 3 is an elevation view of a composite reinforcement made according to one aspect of this disclosure.

FIG. 4 is a cross-sectional view taken along the line 4-4 in FIG. 3.

FIG. 5 is a cross-sectional view taken along the line 5-5 in FIG. 3.

FIG. 6 is a cut-away view of a hinge pillar including a one-piece molded reinforcement and also showing an extension of an A-pillar/roof rail assembly.

FIG. 7 is a side elevation view of a hinge pillar and an A-pillar/roof rail assembly shown partially assembled with a composite reinforcement shown installed prior to assembly of the outer hinge pillar panel.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

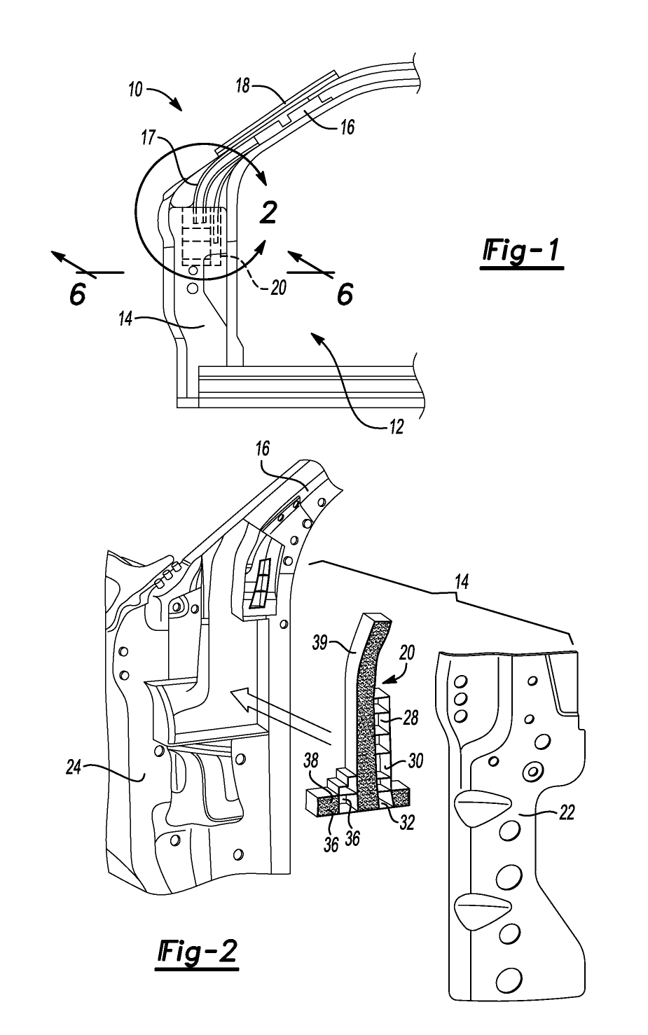

Referring to FIG. 1, a vehicle 10 is partially illustrated that shows the front portion of a passenger compartment 12. Passenger compartment 12 may be defined by a cab of a pickup truck style vehicle 10. A hinge pillar 14 is shown that is adapted to receive the hinges of the front door (not shown) of the vehicle. An A-pillar/roof rail assembly 16 is partially illustrated that includes a hydro-formed tube 17 that extends from inside the hinge pillar 14, along a side of a windshield 18, and along a side of a roof panel (not shown). The hinge pillar 14, A-pillar/roof rail assembly 16, as well as a majority of the structure that defines the passenger compartment 12, may be made from aluminum alloys. The hinge pillar 14, A-pillar/roof rail assembly 16, and hydro-formed tube 17 may be 6xxx series aluminum.

Reinforcement 20 is shown in phantom lines in FIG. 1 that functions to provide additional impact load resistance. The composite reinforcement 20 is a one-piece molded part made of an impact modified toughened nylon that is non-glass filled. The reinforcement 20, when assembled into the hinge pillar area as illustrated, receives loads through a load path extending through a shotgun rail (not shown) that extends substantially longitudinally from a front end of the vehicle 10 to the hinge pillar 14. The shotgun rail transfers a portion of frontal impact loads to the hinge pillar 14 and the reinforcement 20. The reinforcement 20 may aid in the absorption of the energy received from the impact loads, maintain connection of components that make up the hinge pillar 14, and pass impact loads to other components such as the A-pillar/roof rail assembly 16 and hydro-formed tube 17.

Referring to FIG. 2, a first hinge pillar panel 22 is shown exploded from a second hinge pillar panel 24. The first and second hinge pillar panels 22, 24 are assembled to make up at least a portion of hinge pillar 14. The reinforcement 20 is shown disposed between the first hinge pillar panel 22 and the second hinge pillar panel 24. Alternatively, the reinforcement may be assembled between an A-pillar outer reinforcement panel and the hinge pillar. The names used to identify the parts of the hinge pillar 14 or other potential assemblies that may be reinforced may differ, however, the parts that are amenable to receiving the reinforcement 20 include spaced apart facing surfaces for receiving the reinforcement 20.

The reinforcement 20 is formed by a plurality of cells 28 that are open on one side. The cells 28 shown in FIG. 2 are polygonal, or generally cube shaped, in that they have vertical walls 30 and horizontal walls 32 that intersect at right angles to form the cell 28. It should be understood that other polygonal shapes may be formed by intersecting walls such as hexagonal, pentagon, triangular or other shapes that could be used instead of the essentially cube shaped polygonal cells 28 shown in FIG. 2. The cells may be of non-polygonal or non-uniform shapes that follow or complement adjacent parts or the shape of the cavity that receives the reinforcement 20.

Facing walls 36 may be provided on some of the cells 28. The facing walls 36 may be aligned in a substantially vertical pattern, a substantially horizontal pattern, or in a random arrangement. For example, facing walls 36 may be located on a first side of the reinforcement 20 facing the first hinge pillar panel 22 or on a second side of the reinforcement 20 facing the second hinge pillar panel 24. The facing walls may be provided on any combination of the cells 28, and some cells 28 may not have a facing wall 36. The facing walls 36 are provided on the opposite side of the cell 28 from an open end of the cell 28. The cells 28 generally do not have two facing walls 36 on both sides of the cell 28, effectively closing the cell 28.

The adhesive 38 may be injection molded onto a molded nylon carrier 39 as part of the reinforcement 20. The nylon carrier 39 is designed to fit with an otherwise open space within the hinge pillar 14 and A-pillar/roof rail assembly 16 or other environments. The nominal thickness of the reinforcement 20 is governed by design gaps between the panels.

The adhesive 38 may be injection molded onto the carrier 39 or may be applied prior to installation of the reinforcement 20. For example, an injection molded layer 3 mm thick may be provided in its “green” or unexpanded state. The adhesive is expanded when heated in the paint bake ovens to fill in the design gap around the reinforcement 20. The thickness of the adhesive is optimized to avoid bridging large gaps between the reinforcement 20 and an adjacent panel because expanding the adhesive to fill large gaps may result in an unwanted reduction in strength.

An adhesive 38, shown by stippling in FIG. 2, may be injection molded onto or otherwise applied to the facing walls 36 and also other parts of the reinforcement. Clips, fasteners or the adhesive may be used to secure the reinforcement 20 in place during assembly. The adhesive 38 may be partially cured when installed and finally cured when the vehicle body is processed through the paint bake ovens.

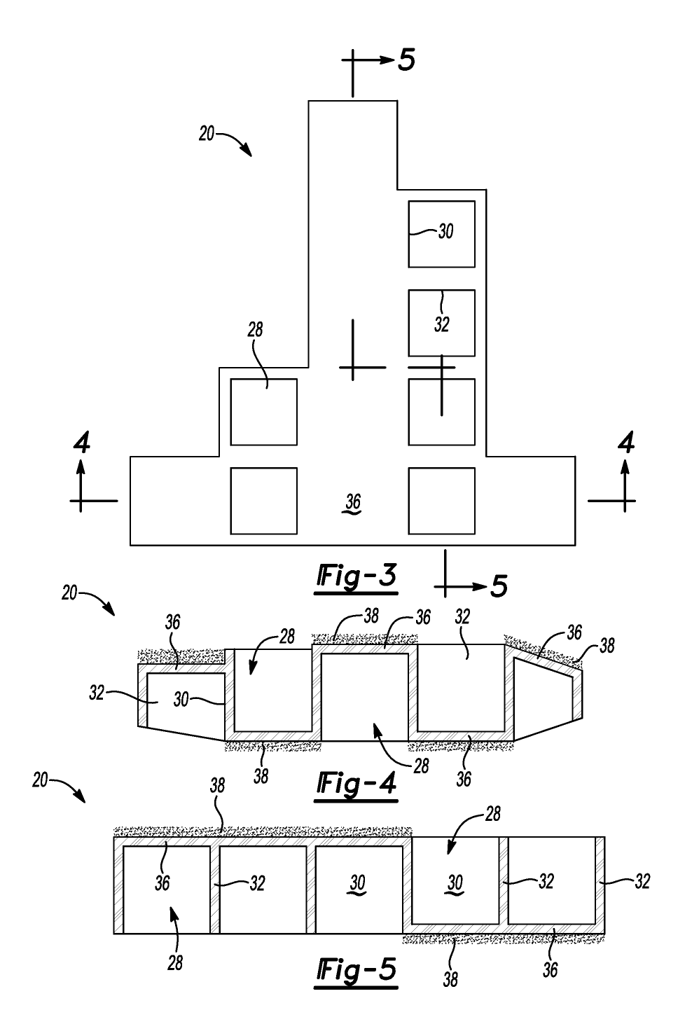

Referring to FIG. 3, the structure of the composite reinforcement is shown diagrammatically and in greater detail. The reinforcement 20 is made up of a plurality of cells 28 that are stacked together and formed by vertical walls 30 and horizontal walls 32 that intersect to form the polygonal cells 28. Facing walls 36 may be provided on one side of each of the cells 28. The facing walls 36 may provide additional stiffness and energy absorbing characteristics to the reinforcement 20. The facing walls 36 may also provide a surface to which an injection molded adhesive is applied or on which an adhesive 38 is otherwise applied (see FIG. 2). The reinforcement 20 may be attached by a clip or other fastener to a facing wall of an adjacent panel, such as the outer hinge pillar panel and hinge pillar reinforcement panel 22, 24 as shown in FIG. 2.

It should be understood that the composite reinforcement 20 may be used in any location in a vehicle body where additional strength or impact absorption is required and where a pocket may be formed between two adjacent body panels to receive the reinforcement. The reinforcement 20 may also be used in other areas of the vehicle body, such as a B-pillar, C-pillar, cowl structure, a running board, or the like.

Referring to FIGS. 4 and 5, cross sections are taken through FIG. 3 in a horizontal line and along a bisected offset vertical line, respectively. The reinforcement 20, as shown in FIG. 3, includes a plurality of cells 28 that are formed by intersecting vertical walls 30 and horizontal walls 32. Facing walls 36 may close off one side of each of the cells 28. An adhesive 38, indicated by the stippling in FIGS. 4 and 5, may be applied to the facing walls 36 to join the composite reinforcement 20 to adjacent vehicle body panels. While adhesive 38 may be used to secure the reinforcement 20 within the body, it is also anticipated that hooks or clips (not shown) or other fastening devices may also be used in place of or in addition to the adhesive 38 to temporarily or permanently secure the reinforcement 20 to adjacent body panels.

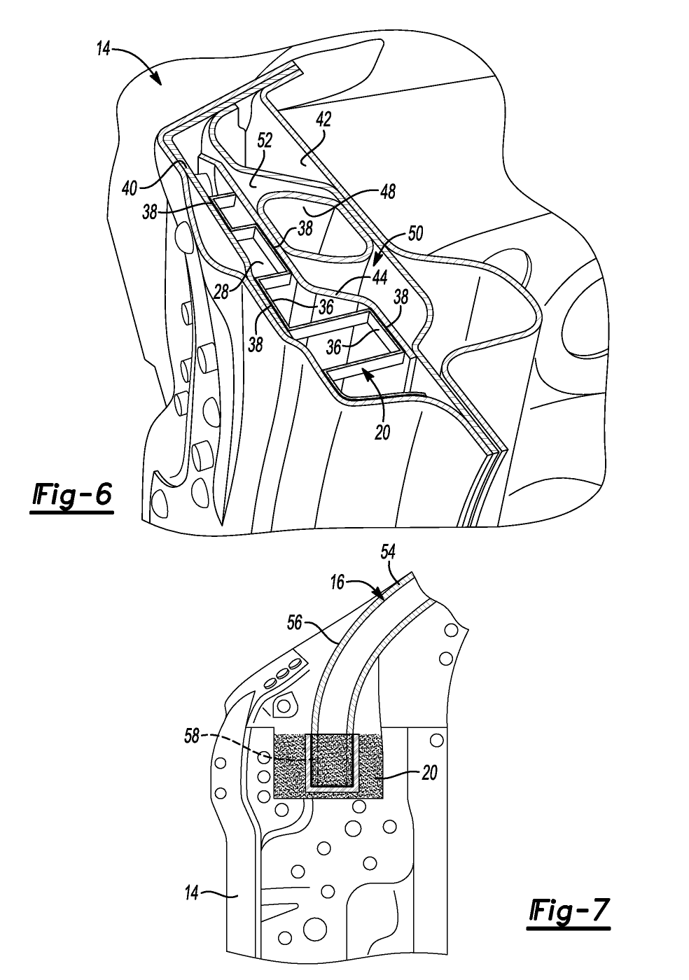

Referring to FIG. 6, a cross-section is taken through a hinge pillar 14 that is fully assembled with the composite reinforcement 20 disposed between a hinge pillar outer panel 40 and a hinge pillar inner panel 42 to which a hinge pillar reinforcement panel 44 is attached. An A-pillar/roof rail assembly 48 is shown to be received in a receptacle 50, or cavity. The cavity 50 is formed by the space between the hinge pillar inner panel 42 and inner hinge pillar reinforcement 52 in the embodiment shown in FIG. 6. The cavity 50 may be defined between other panels, depending upon the availability and access to the space. Adhesive 38 is shown on facing walls 36 of the reinforcement 20. The facing walls 36 and adhesive 38 as shown in FIG. 6 are provided in alternating horizontal pattern with adhesive securing the reinforcement 20 to the hinge pillar outer 40 and the hinge pillar reinforcement panel 44.

The composite reinforcement 20 is formed by the cells 28 and is generally open. The mass of the reinforcement is minimized by the cell structure that is formed of a resilient nylon or other material that provides substantial impact absorption capabilities. The openings in the reinforcement 20 reduce the mass of the reinforcement 20 and limit the extent that the reinforcement functions as a heat sink in the paint bake ovens.

Referring to FIG. 7, an A-pillar/roof rail assembly 16 is partially shown with an upper portion 54 corresponding to the A-pillar/roof rail assembly. The upper portion 54 extends from an intermediate portion 56 that is curved to provide a vertically extending lower extension portion 58 that is received in the hinge pillar 14 along with the reinforcement 20. The A-pillar/roof rail assembly 16 optimizes the load carrying capability of an extruded aluminum A-pillar that is hydro-formed to form the upper portion 54, intermediate portion 56 and lower extension portion 58 in one piece. Other body side structural reinforcements are also attached to the A-pillar/roof rail assembly 16.

The area including the upper portion of the hinge pillar and the lower extension portion 58 of the A-pillar/roof rail assembly is a natural inflection point where loads are applied to the roof structure. With aluminum structures, the reduced thickness and strength of the aluminum sheet metal parts require additional reinforcement to comply with load test requirements. By extending the lower extension portion 58 into the hinge pillar, a stronger joint is provided within the hinge pillar structure 14 that better resists and provides a more continuous load transfer from the roof structure.

The hydro-formed roof rail tube 17 extends vertically downwardly into the hinge pillar structure to produce a more continuous and efficient load transfer in roof tests. The lower extension portion 58 extends down from the curved intermediate portion 56 to transition to the lower extension portion 58 received in the hinge pillar. The efficiency of the joint is optimized by assembling the A-pillar roof rail into the strong hinge pillar structure that is further reinforced by the reinforcement 20 and the reinforcement panels attached to the hinge pillar and the A-pillar.

The embodiments described above are specific examples that do not describe all possible forms of the discourse. The features of the illustrated embodiments may be combined to form further embodiments of the disclosed concepts. The words used in the specification are words of description rather than limitation. The scope of the following claims is broader than the specifically disclosed embodiments and also includes modifications of the illustrated embodiments.

What is claimed is:

1. A reinforcement received between facing surfaces of adjacent panels, comprising:
a reinforcement body including ribs that extend between the facing surfaces in a lattice arrangement defining a plurality of cells; and
a first plurality of walls on a first plurality of cells on one side of the ribs and a second plurality of walls on a second plurality of cells on a second side of the ribs.

2. The reinforcement of claim 1 wherein the first plurality of walls and the second plurality of walls are not provided on the same cells.

3. The reinforcement of claim 1 wherein a first set of the ribs extend in a lateral direction and a vertical direction and a second set of ribs extend in a lateral direction and a horizontal direction between facing surfaces of the adjacent panels that extend in a longitudinal direction and a vertical direction.

4. The reinforcement of claim 1 wherein the cells are polygonal cells that are open on one lateral side.

5. The reinforcement of claim 4 wherein the first plurality of cells is open on an inner lateral sides and the second plurality of cells is open on an outer lateral side.

6. The reinforcement of claim 1 wherein an adhesive is provided on at least some of the first plurality of cells and on at least some of the second plurality of cells to adhere the reinforcement to the facing surfaces of the adjacent panels.

7. The reinforcement of claim 1 wherein the adjacent panels include a hinge pillar outer panel and a hinge pillar reinforcement panel.

8. The reinforcement of claim 7 wherein the first plurality of cells is open on a side facing the hinge pillar outer panel and closed by one of the walls on a side facing the hinge pillar reinforcement, and wherein the second plurality of cells is open on the side facing the hinge pillar reinforcement and closed by one of the walls on the side facing the hinge pillar outer panel.

9. The reinforcement of claim 8 further comprising an adhesive applied to the walls to adhere the reinforcement to the hinge pillar outer panel and the hinge pillar reinforcement panel.

10. The reinforcement of claim 1 wherein the reinforcement body and the first and second plurality of walls are formed as a one-piece molded member.

11. A combination vehicle body structure comprising:
a hinge pillar defining a receptacle; and
an A-pillar/roof rail assembly including an intermediate portion extending along on side of a roof, an upper portion extending along a lateral side of a windshield, and a lower extension portion received in the receptacle of the hinge pillar.

12. The combination of claim 11 wherein the hinge pillar further comprises a hinge pillar outer panel, a hinge pillar inner panel and a hinge pillar reinforcement panel that is assembled between the hinge pillar outer panel and the hinge pillar inner panel.

13. The combination of claim 12 further comprising a reinforcement received between facing surfaces of the hinge pillar outer panel and the hinge pillar reinforcement panel, the reinforcement further comprising:
a reinforcement body including intersecting ribs that extend between the facing surfaces in a lattice arrangement defining a plurality of cells; and
a first plurality of walls on a first plurality of cells on one side of the ribs and a second plurality of walls on a second plurality of the cells on a second side of the ribs.

14. The combination of claim 13 wherein the first plurality of cells is open on a side facing the hinge pillar outer panel and closed by one of the walls on a side facing the hinge pillar reinforcement, and wherein the second plurality of cells is open on the side facing the hinge pillar reinforcement and closed by one of the walls on the side facing the hinge pillar outer panel.

15. The combination of claim 14 further comprising an adhesive applied to the walls to adhere the reinforcement to the hinge pillar outer panel and the hinge pillar reinforcement panel.

16. The combination of claim 11 wherein the A-pillar/roof rail assembly is a hydro-formed tubular member that is formed in one piece to include the intermediate portion, the upper portion, and the lower extension portion.

17. The combination of claim 16 wherein the intermediate portion extends in an angular orientation downwardly and forwardly relative to the upper portion and the lower extension portion extends vertically downwardly from the intermediate portion.

18. The combination of claim 11 wherein the lower extension portion extends through the receptacle portion that is formed between a hinge pillar outer panel and a hinge pillar reinforcement panel.

19. A pickup truck hinge pillar reinforcement comprising:
a composite reinforcement sandwiched between first and second aluminum hinge pillar panels, the reinforcement having a number of cells sharing transversely extending walls defining a perimeter of a polygonal shape for each cell and some cells having a facing wall closing of one side of the cell; and
an adhesive disposed on some of the facing walls securing the reinforcement to the first and second hinge pillar panels.
